(19) United States
(12) Patent Application Publication
(10) Pub. No.: US 2022/0107794 A1
(43) Pub. Date: Apr. 7, 2022

(54) PROGRAM COMPILATION SYSTEM FOR STACKABLE VISUALIZATION CONTROL

(71) Applicant: SU TRON INDUSTRIAL TECHNOLOGY CO., LTD., TAOYUAN CITY (TW)

(72) Inventors: CHIEH-YUAN CHENG, TAOYUAN CITY (TW); CHUN-WEI CHANG, TAOYUAN CITY (TW); PANG-YEN YOU, TAOYUAN CITY (TW)

(21) Appl. No.: 17/064,612

(22) Filed: Oct. 7, 2020

(51) Int. Cl. G06F 8/41; G06F 8/34; G06F 9/4401; G06F 9/451; G06F 11/30; G06F 11/32

(52) U.S. Cl. CPC G06F 8/4441; G06F 8/34; G06F 11/324; G06F 9/451; G06F 11/3058; G06F 9/4411

(57) ABSTRACT

A program compilation system for stackable visualization control is provided for generating a driver program to execute a linking control of automated devices of different functions. The system includes a block module, a card module and a compilation module. The block module has conditional blocks, each being an operation instruction for modularizing each of the automated devices and setting a parameter. The card module has card options corresponding to the automated devices and collected and combined with the respective conditional blocks. When a user selects the card options, the compilation module loads the corresponding conditional blocks for the user to select the required conditional blocks and sets the parameters before forming a program module according to movements and stacking of visualization to compile and generate the driver program. Therefore, end users can improve the freedom and compatibility of a linked operation between the automated devices for customization.

### BACKGROUND

### Technical Field

The present disclosure relates to a graphical programming development platform. More particularly, the present disclosure relates to a program compilation system for stackable visualization control used to directly modularize an operation instruction of different functions or an automated device independently developed by manufacturers, so as to let engineers compile a driver program by using a method similar to a block stacking/splicing method, allow end users to customize and drive various hardware devices according to their requirements, and improve the freedom and compatibility of a linked operation between the automated devices.

### Description of Related Art

Since the advent of graphical development platforms in 1986, long-term consistency is always one of the main features of the graphical development platform. For nearly two decades, scientists and engineers have been attempting to use graphical programming languages to create programs for operations such as automated data acquisition, instrument control, and process testing used by design laboratories, verification laboratories and production plants in order to improve operation efficiency and business performance. As the technology advances, graphical programming languages are no longer limited to the development of a single device program only, but are gradually transformed into a development platform integrated with different tools and functions to ensure a smooth automation process that integrates a plurality of devices. Now, if the best tool of individual functions cannot be integrated with other tools in the process, such tool will lose its advantages. In other word, the engineers and scientists nowadays not only need to provide the best solution for each kind of work they have to complete, but also need a development platform to provide consistent compatibility and productivity. However, it is a major obstacle or challenge for engineers in the field other than the programming related field, such as automation control engineers in the area of man-machine interface planning and design, to overcome the complexity of the graphical development platforms.

In general, hardware developers also develop corresponding driver programs for their products at the same time. To meet different requirements, more and more end users choose to buy automated devices with different functions from different manufacturers and such automated devices are then integrated and driven. However, it is difficult for end users other than the developers to link various automated devices developed from different programming languages. In view of the drawbacks of the prior art, it is a main objective of this disclosure to overcome the drawbacks of the prior art by providing a friendly, interesting, and intuitive visualized programming development platform to assist automated control engineers to further deepen the vertical application area and reducing the difficulty and complexity of the development of the automated device driver program. In the meantime, intuitive graphical programming languages are used to achieve the effects of eliminating the engineer's boring feeling during the compilation such as the compilation of a tabletop game, improving the enthusiasm and effectiveness of the overall operation, and facilitating end users to customize and combine various hardware devices according to requirements and drive the hardware devices, so as to significantly improve the freedom and compatibility of a linked operation between the automated devices.

### SUMMARY

In view of the drawbacks of the prior art, it is a primary objective of the present disclosure to provide a program compilation platform of a block graphical type, wherein a stacking and splicing instruction module is used to assist engineers to complete drafting and editing a driver program of an automated device, and improve the development efficiency of an automated control system and achieve the purpose of expanding the scope of industrial technical applications.

To achieve the aforementioned and other objectives, the present disclosure discloses a program compilation system for stackable visualization control provided for generating a driver program to execute a linking control of a plurality of automated devices of different functions, and the system comprises: a block module, having a plurality of conditional blocks corresponding to the automated devices respectively, and each of the conditional blocks being at least one operation instruction provided for modularizing the automated device and setting at least one parameter; a card module, telecommunicatively coupled to the block module, and having a plurality of card options corresponding to the automated devices respectively, and each of the card options being collected and linked with the respective conditional block; and a compilation module, telecommunicatively coupled to the card module, and having a compiler interface that is graphical, and the card options being displayed on the compiler interface, such that when a user selects the card options, the compilation module loads the corresponding conditional blocks to allow the user to select the conditional blocks for a required action and after the parameter is set, a program module is formed by movements and stacking of visualization, so as to compile and generate the driver program.

The compilation module has a simulator, and when the user successively selects and splices two of the required two conditional blocks, the simulator computes the compatibility of the operation instruction of the two conditional blocks at the background, so as to directly eliminate the conditional block that is later selected when it is incompatible. The simulator simulates the operation of the program module, and generates the driver program when the stack relation between the conditional blocks is correct. Each of the conditional blocks has a shape and a size different from those of at least one other conditional block. When the user sets the parameter of the conditional block, the shape or size of the conditional block is affected and changed by the parameter.

In addition, the compilation module has a plurality of man-machine components compiled into the driver program, and when the automated device executes the driver program, the user views, checks, or controls a progress status of the driver program through each of the man-machine components. The man-machine components are temperature sensing components, warning light components, load rate sensing components, button components, image display components and camera components. The block module has a graphical self-created interface provided for the user to self-define and produce each of the conditional blocks. When the user selects the card options, the compilation module loads the corresponding conditional blocks and expands the conditional blocks in different pages according to the card options respectively. The user stacks and forms the program modules with a plurality of types according to the card options, and the simulator automatically and sequentially connects the program modules and computes the program modules to form the driver program.

In summation of the description above, each of the conditional block is an operation instruction provided for modularizing each of the automated devices, so that the user can directly use a method of visualizing movements to stack or splice the conditional blocks to compile and generate the driver programs for controlling the automated devices of different functions, so as to reduce the operation complexity of the program compilation and facilitate the users to develop programs and maintain the operation efficiency. In addition, the users can select the required device from the card options, so that the compilation module will show the corresponding block set and allow the users to directly use the conditional blocks in the set in order to simplify the compilation and gain a low entry for the operation.

### BRIEF DESCRIPTION OF THE DRAWINGS

FIG. 1 is a block diagram showing the structure of a first preferred embodiment of this disclosure;

FIG. 2 is a block diagram showing the structure of a second preferred embodiment of this disclosure;

FIG. 3 is a flow chart of the second preferred embodiment of the present disclosure;

FIGS. 4A and 4B are schematic views of a compiler interface in accordance with the second preferred embodiment of the present disclosure; and

FIGS. 5A and 5B are schematic views of a self-created interface in accordance with the second preferred embodiment of the present disclosure.

### DESCRIPTION OF THE EMBODIMENTS

The accompanying drawings are included to provide a further understanding of the disclosure, and are incorporated in and constitute a part of this specification. The drawings illustrate embodiments of the disclosure and, together with the description, serve to explain the principles of the disclosure.

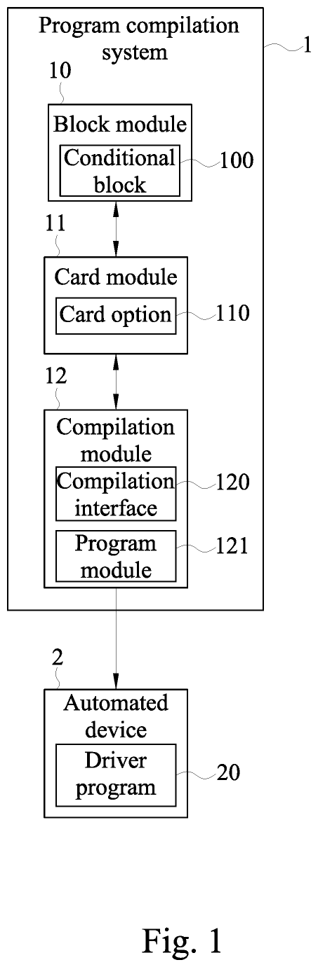

With reference to FIG. 1 for a block diagram showing the structure of a first preferred embodiment of this disclosure, the program compilation system for stackable visualization control 1 comprises a block module 10, a card module 11 and a compilation module 12, and the program compilation system 1 is provided for generating a driver program 20 to execute a linking control of a plurality of automated devices 2 of different functions. The block module 10 has a plurality of conditional blocks 100 corresponding to the automated devices 2 respectively, and each of the conditional blocks 100 is at least one operation instruction provided for modularizing the automated device 2 and setting at least one parameter. The card module 11 has a plurality of card options 110 corresponding to the automated devices 2 respectively, and each of the card options 110 is collected and combined with each of the corresponding conditional blocks 100. The compilation module 12 has a compiler interface 120 that is graphical, and the block module 10 is telecommunicatively coupled to the card module 11, and the card module 11 is telecommunicatively coupled to the compilation module 12. The compiler interface 120 shows the card options 110 thereon, so that when the user selects the card options 110, the compilation module 12 loads the corresponding conditional blocks 100 provided for the user to select the required conditional blocks 100 and set the parameter, and then movements and stacking of visualization is used to form a program module 121, so as to compile and generate the driver program 20.

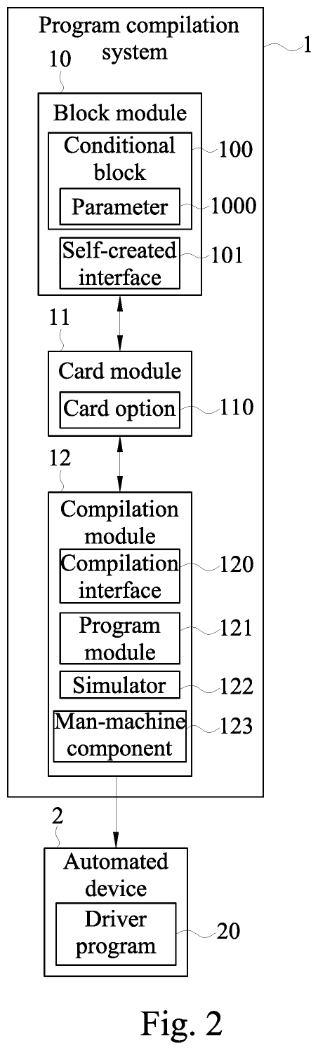

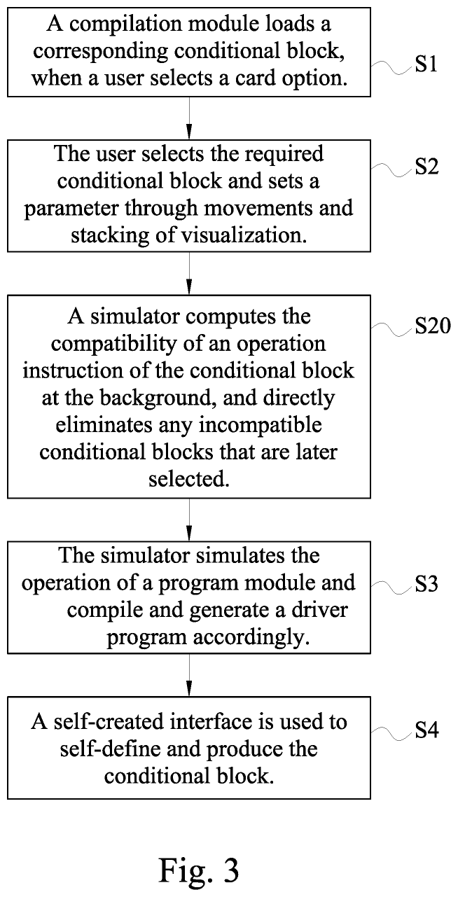

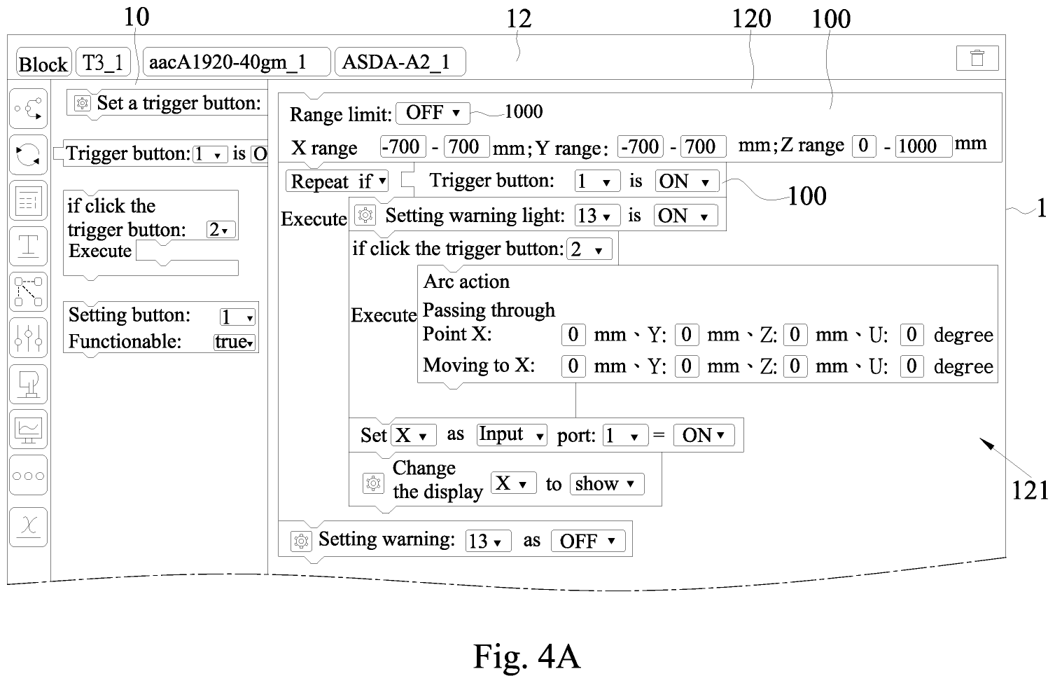

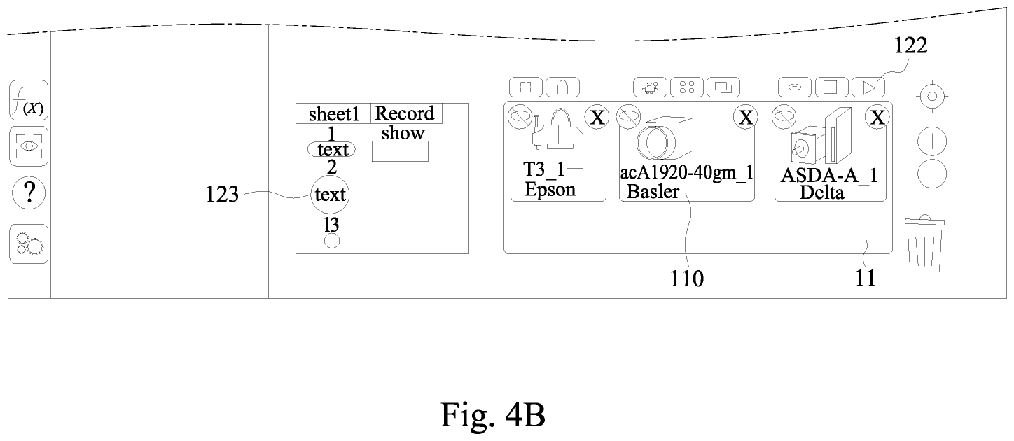

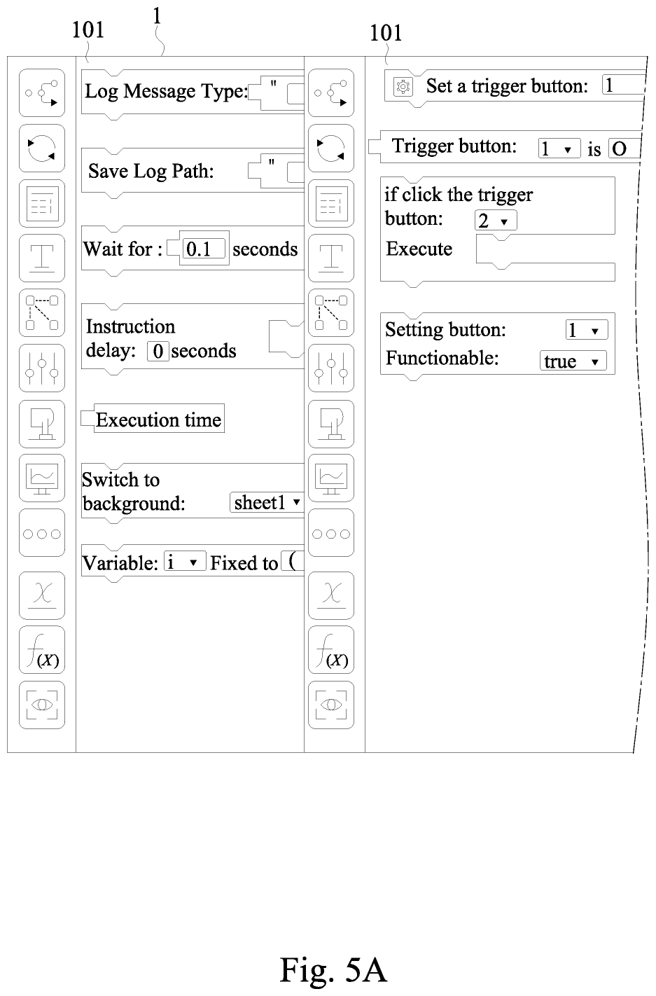

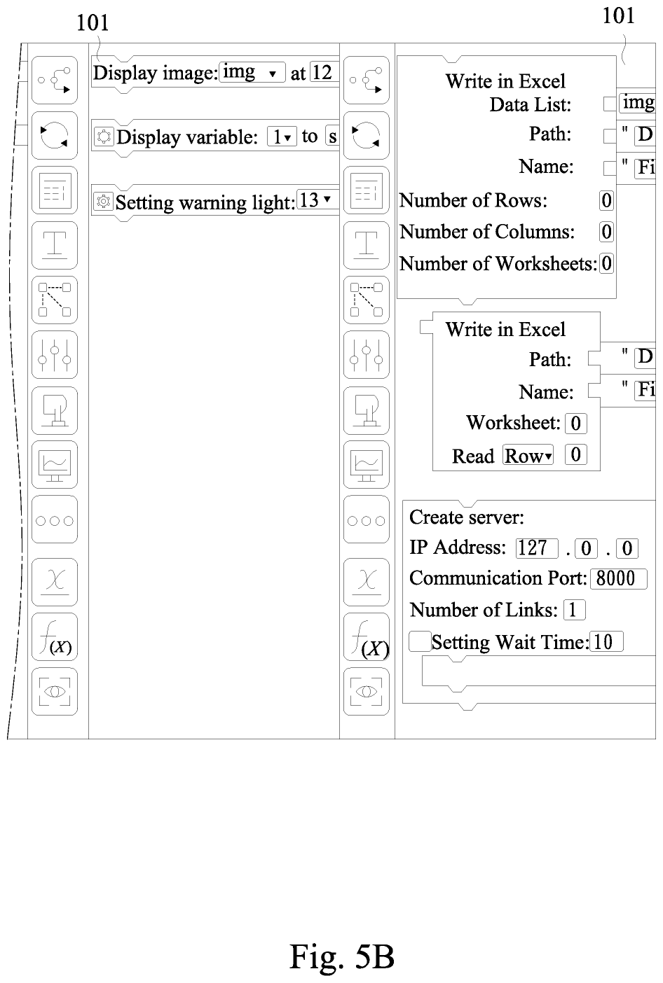

With reference to FIGS. 2 to 5B for the block diagram of the structure, the flow chart, and different schematic views of the second preferred embodiment of this disclosure respectively, the program compilation system for stackable visualization control 1 is used for generating a driver program 20 to execute a linking control of a plurality of automated devices 2 of different functions such as surveillance cameras, robotic arms or light source lamps, and the system comprises a block module 10, a card module 11 and a compilation module 12, and the block module 10 is telecommunicatively coupled to the card module 11, and the card module is telecommunicatively coupled to the compilation module 12. The block module 10 has a plurality of conditional blocks 100 corresponding to the automated devices respectively, and a graphical self-created interface 101, and each of the conditional blocks 100 is at least one operation instruction for modularizing the automated device 2 and setting at least one parameter 1000, and the shape and size of the conditional blocks 100 has at least one different from those of other condition blocks 100. The card module 11 has a plurality of card options 110, and each of the card options 110 is corresponsive to each of the respective automated devices 2, and the card options 110 are collected and combined with the corresponding conditional blocks 100 respectively. The compilation module 12 comprises a compiler interface 120 that is graphical and a simulator 122.

The compiler interface 120 shows the card options 110 thereon. In Step (51), when a user selects the card options 110, the compilation module 12 loads the corresponding conditional blocks 100, and expands the conditional blocks in different pages according to the card options 110 respectively. In Step (S2), the user selects the required operation from the conditional blocks 100 and sets the parameter 1000, and then a visualization of movements and stacks is used or the conditional blocks 100 is spliced to form a program module 121. Now, the user has successively selected the required two conditional blocks 100 and combined them, in Step (S20), the simulator 122 computes the compatibility of the operation instructions of the two conditional blocks 100 at the background, so as to directly eliminate the conditional block that is later selected when it is incompatible. In addition, when the user sets the parameter 1000 of the conditional block 100, shape or size of the conditional block 100 is affected and changed by the parameter 1000, so that it is impossible to just have a side-by-side peer-to-peer stacking relationship between the conditional blocks 100 only, but there may be a master-slave splicing relation such as interpolation or surrounding. For example, if the conditional blocks 100 are in a peer-to-peer relation, after a surveillance camera takes a picture, a robotic arm will move a distance; if the conditional blocks 100 are in a master-slave splicing relation, after a camera head of a surveillance camera rotates an angle, a robotic arm will move a distance, and then the surveillance camera will take a picture again.

In Step (S3), the simulator 122 simulates the operation of the program module 121 to compile and generate the driver program 20 when the stack relation between the conditional blocks 100 is correct. It is noteworthy that the compiler interface 120 allows the user to stack or splice in order to form the program module 121 in a page of the respective card option 110 according to the difference of each card option 110. In other words, the program module 121 has a plurality of types, so that the simulator 122 automatically combines the program modules 121 according to the sequence of the pages and computes and generates the driver program 20.

In Step (S4), the user can use the self-created interface 101 to self-define and produce each of the conditional blocks 100, so as to improve the number of conditional types of the conditional blocks 100 and the diversity of the instructions, and achieve the performance of the industrial development by a highly customized automation system. It is worthy to mention that the compilation module 12 can have a plurality of man-machine components 123, and the man-machine components 123 can be temperature sensing components, warning light components, load rate sensing components, button components, image display components and camera components provided and compiled in the driver program 20. When the automated device 2 executes the driver program 20, the user can use each of the man-machine components 123 to view, check or control a progress status of the driver program 20, so as to ensure a perfect and convenient operation of the driver program 20.

What is claimed is:

1. A program compilation system for stackable visualization control, provided for generating a driver program to execute a linking control of a plurality of automated devices of different functions, comprising:
a block module, having a plurality of conditional blocks corresponding to the automated devices respectively, and each of the conditional blocks being at least one operation instruction provided for modularizing the automated device and setting at least one parameter;
a card module, telecommunicatively coupled to the block module, and having a plurality of card options corresponding to the automated devices respectively, and each of the card options being collected and linked with the respective conditional blocks; and
a compilation module, telecommunicatively coupled to the card module, and having a compiler interface that is graphical, and the card options being displayed on the compiler interface, such that when a user selects the card options, the compilation module loads the corresponding conditional blocks to allow the user to select the conditional blocks for a required action and after the parameter is set, a program module is formed by movements and stacking of visualization, so as to compile and generate the driver program.

2. The program compilation system as claimed in claim 1, wherein the compilation module has a simulator, and when the user successively selects and splices two of the required two conditional blocks, the simulator computes the compatibility of the operation instructions of the two conditional blocks at the background, so as to directly eliminate the conditional block that is later selected when it is incompatible.

3. The program compilation system as claimed in claim 2, wherein the simulator simulates the operation of the program module, and generates the driver program when the stack relation between the conditional blocks is correct.

4. The program compilation system as claimed in claim 3, wherein each of the conditional blocks has a shape and a size different from those of at least one other the conditional blocks.

5. The program compilation system as claimed in claim 4, wherein when the user sets the parameter of the conditional block, the shape or size of the conditional block is affected and changed by the parameter.

6. The program compilation system as claimed in claim 5, wherein the compilation module has a plurality of man-machine components compiled into the driver program, and when the automated device executes the driver program, the user views, checks, or controls a progress status of the driver program through each of the man-machine components.

7. The program compilation system as claimed in claim 6, wherein the man-machine components are temperature sensing components, warning light components, load rate sensing components, button components, image display components and camera components.

8. The program compilation system as claimed in claim 7, wherein the block module has a graphical self-created interface provided for the user to self-define and produce each of the conditional blocks.

9. The program compilation system as claimed in claim 8, wherein when the user selects the card options, the compilation module loads the corresponding conditional blocks and expands the conditional blocks in different pages according to the card options respectively.

10. The program compilation system as claimed in claim 9, wherein the user forms the program modules with a plurality of types according to stacking the card options, and the simulator automatically and sequentially connects the program modules and computes the program modules to form the driver program.
